(19) United States
(12) Patent Application Publication
(10) Pub. No.: US 2023/0350087 A1
(43) Pub. Date: Nov. 2, 2023

(54) Methods and Systems for Time-Efficient Seismic Prospecting

(71) Applicant: INOVA LTD., George Town (KY)

(72) Inventors: Hua Ai, Calgary (CA); Arjun Selvakumar, Houston, TX (US)

(73) Assignee: INOVA LTD., George Town (KY)

(21) Appl. No.: 17/778,803

(22) PCT Filed: Nov. 23, 2020
(86) PCT No.: PCT/US2020/061795

§ 371 Date: May 20, 2022

Related U.S. Application Data
(60) Provisional application No. 62/939,095, filed on Nov. 22, 2019.

(51) Int. Cl. G01V 1/00; G01V 1/09

(52) U.S. Cl. CPC G01V 1/005; G01V 1/09

(57) ABSTRACT

A seismic survey uses a central control and a seismic source. The seismic source has a vibrator that acoustically couples to the ground using a moveable pad. A method for performing a seismic survey includes sending a first message from the seismic source to the central control indicating a time at which the pad is being lowered; estimating a time at which the pad will be acoustically coupled to the ground based on the first message; and sending a message from the central control to the seismic source to begin a sweep, the sweep beginning no sooner than the estimated time. Another method includes: mapping a surface of a terrain to be traversed by the truck using at least one sensor carried by the truck; positioning a moveable pad based on the mapped surface to provide a physical gap between the surface and the moveable pad; and traversing the mapped terrain with the truck.

### BACKGROUND OF THE DISCLOSURE

### 1. Field of the Disclosure

This disclosure relates generally to systems and methods for efficient operation of equipment used for seismic survey operations.

### 2. Background of the Art

Seismic surveys are conducted to map subsurface structures to identify and develop oil and gas reservoirs. Seismic surveys are typically performed to estimate the location and quantities of oil and gas fields prior to developing (drilling wells) the fields and also to determine the changes in the reservoir over time subsequent to the drilling of wells. For example, seismic surveys in the Middle East and in other regions use vibrator trucks (“vibe trucks”) and vibroseis source methods to introduce acoustic energy into the earth so that reflection and refraction seismometry can be employed. In many of these regions, due to the scale and project costs, it is desirable to both the seismic contractor and the end client that the acquisition project be completed quickly and efficiently.

Typically, the function of the vibrator truck is to move to shot points and impart a source energy of a given signature into the ground. This process is repeated for all the planned shot points within the survey map. The faster the vibe truck can move to each shot point and initiate the sweep, the higher the productivity achievable by each vibe truck within the acquisition area.

The cycle time between one sweep and the next determines how many sweeps can be carried out in one day. The time duration between the completion of one sweep and the initiation of the next sweep can be viewed as dead time or as an inefficiency. In aspects, the present disclosure provides systems and methods for reducing these inefficiencies.

### SUMMARY OF THE DISCLOSURE

In aspects, the present disclosure provides a method for performing a seismic survey. The seismic survey may be done using a central control and a seismic source. The seismic source has a vibrator that acoustically couples to the ground using a moveable pad. The method may include the steps of: sending a first message from the seismic source to the central control indicating a time at which the pad is being lowered; estimating a time at which the pad will be acoustically coupled to the ground based on the first message; and sending a message from the central control to the seismic source to begin a sweep, the sweep beginning no sooner than the estimated time.

In further aspects, the present disclosure provides method that may include the steps of: mapping a surface of a terrain to be traversed by the truck using at least one sensor carried by the truck; positioning a moveable pad based on the mapped surface to provide a physical gap between the surface and the moveable pad; and traversing the mapped terrain with the truck.

Examples of certain features of the systems, methods and apparatus disclosed herein have been summarized rather broadly in order that detailed description thereof that follows may be better understood, and in order that the contributions to the art may be appreciated. There are, of course, additional features of the disclosure that will be described hereinafter and will form the subject of the disclosure. The summary provided herein is not intended to limit the scope.

### BRIEF DESCRIPTION OF THE DRAWINGS

The novel features of this disclosure, as well as the disclosure itself, will be best understood from the attached drawings, taken along with the following description, in which similar reference characters generally refer to similar elements, and in which:

FIG. 1 schematically illustrates one embodiment of a seismic survey system in accordance with the present disclosure;

FIG. 2 schematically illustrates various positions of a pad for a vibrator;

FIG. 3 illustrates the sequence of events related to performing seismic sweeps using prior art methods;

FIG. 4 illustrates the sequence of events related to performing seismic sweeps in accordance with one embodiment of the present disclosure;

FIG. 5 schematically illustrates vibe truck with a pad in a “pad up” position;

FIG. 6 illustrates a vibe truck that includes sensors for mapping terrain according to one embodiment of the present disclosure; and

FIG. 7 schematically illustrates pads in a “pad up” position, “intermediate” position, and “pad down” position in accordance with one embodiment of the present disclosure.

### DETAILED DESCRIPTION

The present disclosure relates to devices and methods for controlling activities relating to seismic data acquisition. In particular, the present disclosure is directed to the seismic survey market, especially in super crew market segments, wherein shooting efficiency is a key performance indicator. The teachings of the present disclosure may be applied to reduce delays between sweeps. The present disclosure may be implemented in embodiments of different forms. The drawings shown and the descriptions provided herein correspond to certain specific embodiments of the present disclosure for the purposes of explanation of the concepts contained in the disclosure with the understanding that the present disclosure is to be considered an exemplification of the principles of the disclosure, and is not intended to limit the scope of the disclosure to the illustrated drawings and the description herein.

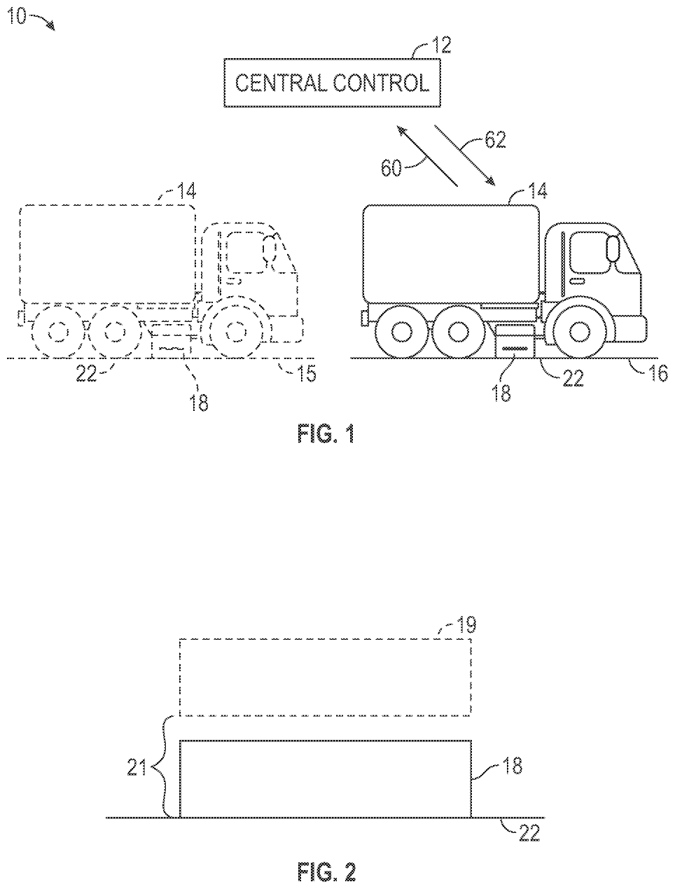

Referring to FIG. 1, a seismic survey system 10 may include a central control 12 and one or more seismic sources 14 conveyed by a vehicle. The seismic source 14 may be a vehicle-conveyed hydraulically powered vibrator that imparts seismic energy into the ground at a selected shot point 16 using a pad 18. Sometimes, a pad is referred to as a “base plate.” In a conventional mode of operation, the seismic source 14 moves between multiple shot points. In FIG. 1, a seismic source 14 drawn in hidden lines is shown at a prior shot point 15. The pad 18 is shown in a “pad down” position in FIG. 1. In FIG. 2, the pad 18 is shown in the “pad down” position. For reference, a pad 19 drawn in hidden lines is shown in the “pad up” position. Thus, generally, a “shot point” is a physical location on a geographical terrain of interest.

Referring to FIG. 2, the pad 18 is shown physically contacting the ground 22, which is a necessary condition in order to impart seismic energy into the ground 22. The pad 19 drawn in hidden lines is positioned such that a gap 21 separates the pad 19 and the ground 22. The position of pad 19 is generally representative of a condition wherein seismic energy cannot be imparted into the ground 22. The position of pad 19 can occur while the seismic source 14 is moving between shot points (e.g., between points 15 and 16 of FIG. 1).

In an illustrative operating mode, the seismic source 14 first positions itself at one shot point and lowers the pad to contact the ground 22. It may take three to 5 seconds or more to move from the position of pad 19 to the position of pad 18. Once physical contact with the ground 22 and other requirements such as appropriate “hold down” weight is established, the central controller 12 (FIG. 1) sends a signal that initiates a “sweep.” For the purposes of the present disclosure, a pad 18 is considered acoustically coupled to the ground 22 after physical contact is established and other criteria such as a minimal hold down weight are present. During a “sweep,” the seismic source imparts seismic energy into the ground 22. A typical “sweep” may last five to twenty seconds. Once the sweep is complete, the pad 18 is lifted off the ground 22 and the seismic source 14 moves to the next shot point.

In aspects, the present disclosure addresses two delay factors in the operation cycle that may get repeated thousands of times a day, which translates into significant shooting efficiency impact.

Referring to FIG. 1, in conventional seismic survey operation modes, the decision to start a sweep is made at a central control 12 instead of at the seismic source 14. A sweep does not start until the pad 18 is down and the central control 12 is informed of that condition. With prior art systems, several seconds pass while waiting for the pad 18 to contact the ground 22 (or “pad down” process) and several seconds pass until a signal indicative of such contact, (or “ready signal” process) is received at the central control 12.

In accordance with embodiments of the present disclosure, these two processes occur in parallel so that a ready message 60 (FIG. 1) is sent when the pad down process starts, instead of after the pad down process is completed. In aspects, the ready message does not inform the central control 12 that the seismic source 14 is ready, but rather provide sufficient information to allow the central control 12 to predict when the seismic source 14 is likely to be ready. This may be referred to as a “predictive ready message.”

Referring to FIG. 3, there is shown a time chart illustrating a prior art sequence of events for operating a seismic source 14. Referring to FIGS. 1 and 3, in response to a signal from central control 12 (FIG. 1), the seismic source 14 performs a sweep at a first location, e.g., location 15, which is labeled as event 30. Event 32 is a lifting of the pad 18 off of the ground 22. After the pad 18 has been lifted, event 34 is moving the seismic source 14 to the next location, e.g., location 16. Event 36 is a lowering of the pad 18 into contact with the ground 22. Once the pad 18 has contacted the ground 22, event 38 is a transmission of a signal from the seismic source 14 to the central control 12 that the seismic source 14 is ready to perform a sweep. Event 40 includes a signal from the central control 12 to start the sweep and the subsequent sweep.

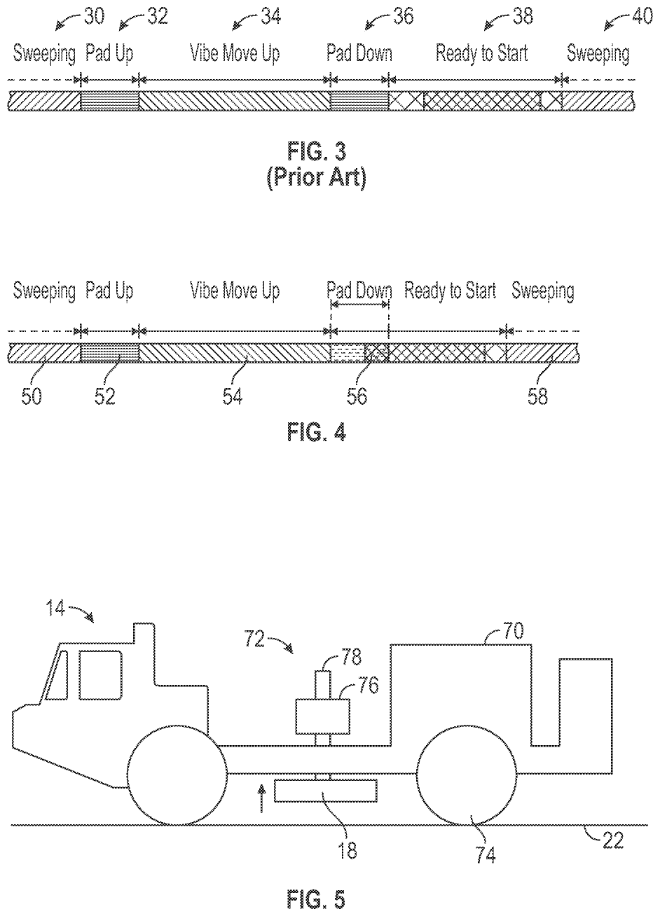

Referring to FIG. 4, there is shown a time chart illustrating a sequence of events for a operating a seismic source 14 in accordance with embodiments of the present disclosure. Referring to FIGS. 1 and 4, in response to a signal from central control 12 (FIG. 1), the seismic source 14 performs a sweep at a first location, e.g., location 15, which is labeled as event 50. Event 52 is a lifting of the pad 18 off of the ground 22. After the pad 18 has been lifted, event 54 is moving the seismic source 14 to the next location, e.g., location 16. Event 56 involves two actions that occur at or about the same time. The first action is that the seismic source 14 begins to lower the pad 18, or the “pad down” process. The second action is a message that is sent from the seismic source 14 to the central control 12 that indicates that the pad 18 is being lowered, which is referred to as a “predictive ready message.” In one non-limiting method, the predicative ready message contains a timestamp of when the pad down process actually started. In another non-limiting method, the predicative ready message contains a timestamp of when the pad down process is expected to start. The predictive ready signal may also notify the central control 12 of the initial position of the pad 18.

In one arrangement, the central control 12 may have simulations, test data, and/or actual “in-field” obtained data relating to the operating characteristics and behavior of the seismic source 14. These may be referred to as “parameters” of the seismic source 14. For example, the pad vertical position may be measured after the hold down weight is fully applied to the pad. By “fully applied,” it is the minimum weight needed in order to apply a specified force to the ground 22. Based on this information, central control 12 can estimate how long the “pad down” process would take to complete. Thereafter, the central control 12 can use the estimated completion time to determine when a sweep can be started. Event 58, which is the sweep, commences after the seismic source 14 receives a command message 62 (FIG. 1) from the central control 12 to start the sweep. The central control 12 or another information processor may estimate time using one or more parameters of the seismic source, which include, but are not limited to: an initial position of the pad prior to descent, a final position of the pad after descent, distance the pad must travel to move between the initial position and the final position, acceleration of the pad, velocity of the pad, variation in the rate of descent of the pad, expected time the descent will begin, actual time descent began, distance between point when descent began and the next shot point, etc. Thus, in some embodiments, the parameters relate to time, distance, position, speed and acceleration.

The performance of the hydraulic system used to lift pad 18 up and lower the pad 18 down may vary from one seismic source 14 to the next, which leads to time variations in pad down process of different seismic sources. If the pad down process takes longer than predicted for whatever reason, the sweep may not start successfully. Therefore, in one variation, to increase the success rate of prediction, the central control 12 may apply a safety margin to the predicted pad down completion time. The safety margin may be, for example, increasing the estimated pad down completion time by five percent or ten percent. As used herein, a “safety margin” is a multiplier applied to an estimated value that accommodates variations in system behavior. Thus, an estimated time of ten seconds and a safety margin of ten percent may result in a predicted time to lower the pad, or pad descent, of eleven seconds.

In a related variation, the applied safety margin may be dynamically adjusted. For example, the actual time required to complete the pad down process may be measured and recorded at each shot location. Tracking records may be established for every seismic source 14 that is being controlled by the central control 12. Thereafter, the actual time to complete the pad down process may be compared with the estimated pad down process. The difference in time, if any, may be used to reduce or increase the safety margin as needed.

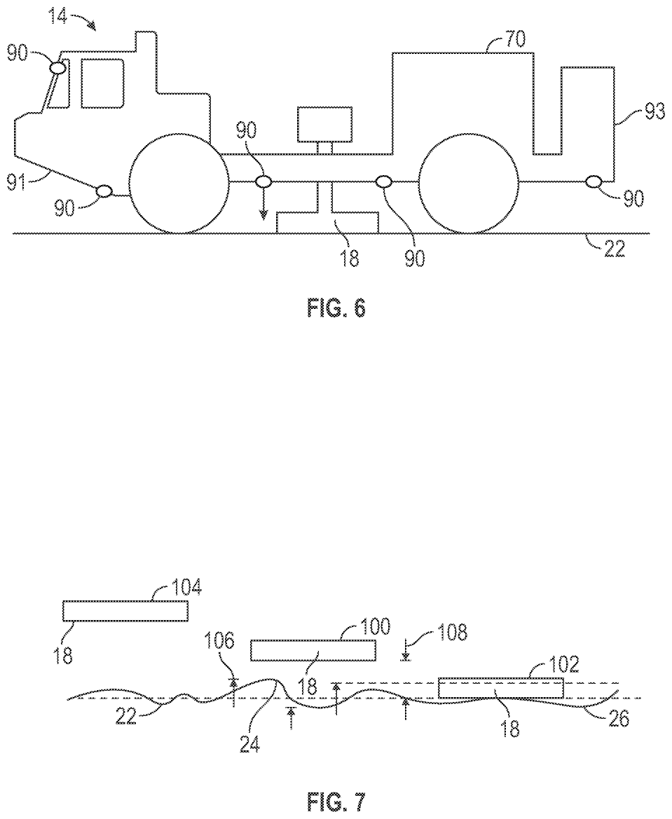

Reductions in delays attributable to moving the pad 18 between two positions may also be obtained using other methods according to the present disclosure. Referring to FIG. 5, a seismic source 14 may be a vibe truck 70 that carries a hydraulically-actuated vibrator 72 that acoustically couples to the ground 22 by using a pad 18. During operation, after reaching a selected shot point, the vibrator truck 70 utilizes the hydraulically-actuated vibrator 72 to lower the pad 18 toward the ground 22 and into the ‘pad down’ position. The vibrator 72 continues to apply a hydraulic force until the truck 70 is almost completely lifted off the ground 22 with only a fraction of the weight of the truck 70 being borne by the wheels 74. The pad 18 becomes the support holding the truck 70 stationary, thus introducing a hold down weight on the pad 18 as shown in FIG. 6.

Next, a reaction mass 76 is hydraulically moved around a piston 78 that is mechanically coupled to the pad 18, in an oscillatory motion defined by the sweep signature. This motion imparts an equal and opposite force on the pad 18. Since the pad 18 is acoustically coupled to the ground 22, this force is transmitted into the ground 22. Once the sweep duration is completed, the pad 18 is lifted into the ‘pad up’ position thus lowering the truck 18 fully down and supported only by the wheels 74 as shown in FIG. 5. After the completion of the sweep, the vibrator truck 70 is driven to the next shot point and the sweep is once again imparted into the ground 22.

Lowering the pad 18 or raising the pad 18 can take several seconds. When the total cycle time is in the order of fifteen to thirty seconds, three to five seconds for each pad movement can significantly impact the total cycle time and thus the overall productivity that can be achieved.

In accordance with the present disclosure, sensory systems may be used to position the pad 18 to minimize the amount of lowering and raising that must be done while performing sweeps. FIG. 6 illustrates sensors 90 that may be positioned at different locations on the truck 70. These sensors 90 may include ultrasonic sensors, which are near field proximity sensors that provide a range of 5 cm up to 2 m. Other sensors may include Infrared, radar and LiDAR sensors, which provide a forward-looking ranging information of few meters to 50 meters. One or more of these sensors may also be used for vehicle guidance, automation, safety and monitoring terrain conditions.

One non-limiting arrangement includes integrating sensing and imaging technologies such as Radar, LiDAR, Visible and IR spectrum cameras such that near field terrain mapping is imaged and appropriate precautions taken. This is desirable for at least two reasons: 1) to ensure driver/operator safety and asset protection in avoiding potential damage caused to the vehicle in rugged, non-paved fields and 2) to provide confidence to the seismic contractor with the ‘near-autonomous’ operation of the vehicle.

Referring to FIG. 7, during operation, terrain condition and measurements are used to calculate an intermediate position 100 or ‘hover’ position for the pad 18. An intermediate position is a position wherein the pad 18 is neither in physical contact with the ground 22, the “pad down” position 102, nor raised to point where the pad 18 cannot be raised further, or the “pad up” position 104. In one illustrative method, the intermediate position is calculated using a moving average of the ground clearance measurements from the underbody ultrasonic sensors 90. Referring to FIGS. 6 and 7, a statistical averaging and representative method such as but not limited to weighted moving average (WMA) is computed using the near field sensor measurements that indicate peaks 24 to valleys 26 from the sensors 90 in a front 91 and at a rear 93 of the vehicle 70 with a higher bias given to the forward sensors 90 in order to estimate a WMA value 106, all calculated relative to the mean ground level. A safety margin is added to create an adequate clearance 108 underneath the pad and the ground being traversed. The mean ground level is updated based on the resting position of the pad on the ground before the vehicle is lifted up. The updated value is compared to the calculated main and corrections are adaptively made

A safety margin may be added; e.g., a fifty or one hundred percent factor is applied such that adequate clearance is present underneath the pad 18 and the ground 22 being traversed. Additionally, the LiDAR cameras providing imaging and ranging in front of the vehicle 70 up to a distance of 50 m is used to anticipate any sudden changes in the terrain such as a dip or mound or an obstacle that is small enough to pass under the truck 70 but high enough to strike the pad 18 in the intermediate position 100.

The pad 18 may be maintained in the intermediate position 100 in between sweeps and lowered to the ‘DOWN’ position during a sweep. Based on terrain conditions, the pad 18 may not be required to travel the full distance when adequate ground clearance is available. Thus, pad 18 travel time is reduced and total cycle time inefficiency is reduced. For example, in the fully ‘pad up’ position 104, typical ground clearance underneath the pad 18 can be around 0.5 m. In many cases, the local ground variability is in the order of 10˜20 cms or less. As such 2 seconds could be saved within a 17 second cycle time. Moreover, when the vehicle 70 has completed the sweep, the pad 18 need only clear a distance 24 above the mean ground level, before the vehicle 70 can be driven forward. The vibe truck operator does not need to wait until the entire distance 108 is cleared by the pad 18 prior to being driven forward.

The present teachings takes into consideration the terrain conditions and to operate the pad 18 at an optimal position that is within the safe operation of the truck 70 while at the same time minimizing pad-down delays. The optimal positioning may also minimize costly damage and delays resulting in repairing the truck 70 and/or the equipment carried by the truck 70. Lastly, operational consistency can be maintained avoiding variability seen with operators' skill levels and their handling of the vibe truck.

From the above, it should be appreciated that the present disclosure provides systems and methods that efficiently raise and lower a pad before and after a sweep. Inventive aspects include, but are not limited to: using proximity sensors such as ultrasonic sensors in the underbody of a vehicle; calculating a mean ground clearance using the proximity sensors as the vehicle is in forward motion; using the peak to valley ground clearance information and the mean and adding a safety margin such that an ‘safe’ ground clearance value is calculated; holding the pad at a position such that this safe clearance is maintained, which reduces the time for the pad to be moved for sweeping; and using LiDAR information to anticipate sudden changes in ground clearance within a range of 50 m in front of the vehicle and using that information to take safety precautions of lifting the pad to a higher.

From the above, it should be appreciated that what has been described include a method for performing a seismic survey using a central control and a seismic source. The seismic source has a vibrator that acoustically couples to the ground using a moveable pad. The method includes the steps of: sending a first message from the seismic source to the central control indicating a time at which the pad is being lowered; estimating a time at which the pad will be acoustically coupled to the ground based on the first message; and sending a message from the central control to the seismic source to begin a sweep, the sweep beginning no sooner than the estimated time.

In embodiments, the time is estimated using at least one operating parameter of the seismic source; the estimated time includes a margin of safety; the estimated time is updated based on pad position measurements in the pad down position after the hold down weight is fully applied; the first message include an actual time at which the pad began being lowered; and/or the first message includes a predicted time at which the pad will be lowered. In embodiments, the method may include the steps of operating the seismic source at a first shot point; and moving the seismic source to a second shot point, wherein the first message is sent before the seismic source arrives at the second shot point.

From the above, it should be appreciated that what has been described also includes a method for performing a seismic survey using a central control and a seismic source carried by a truck. The seismic source has a vibrator that acoustically couples to the ground using a moveable pad. The method may include the steps of: mapping a surface of a terrain to be traversed by the truck using at least one sensor carried by the truck; positioning a moveable pad based on the mapped surface to provide a physical gap between the surface and the moveable pad; and traversing the mapped terrain with the truck.

In embodiments, the moveable pad can be positioned at a pad down position, the movable pad physically contacts the ground and a pad up position, the movable pad is furthest from the pad down position, and the moveable pad is positioned at an intermediate position between the pad down position and the pad up position based on the mapped surface. In embodiments, the method includes the steps of operating the seismic source at a first shot point; moving the seismic source to a second shot point; and moving the pad from the pad down position to the intermediate position while moving the seismic source to the second shot point. In embodiments, the method includes the steps of moving the pad from the intermediate position to the pad down position after the seismic source arrives at the second shot point or moving the pad from the intermediate position to the pad down position before the seismic source arrives at the second shot point.

In embodiments, the moveable pad is positioned using a safety margin and/or the pad position measurements in the pad down position prior to hold down weight being applied are used to update the calculated mean ground level.

From the above, it should be appreciated that the present disclosure includes teachings relating to reduce delays associated with lowering and raise the pad, thus speeding up the cycle of sweeps and moving to a new shot point. The disclosure herein is provided in reference to particular embodiments and processes to illustrate the concepts and methods. Such particular embodiments and processes are not intended to limit the scope of the disclosure or the claims. All such modifications within the scope of the claims and disclaimers are intended to be part of this disclosure.

What is claimed is:

1. A method for performing a seismic survey using a central control and a seismic source, the seismic source having a vibrator that acoustically couples to the ground using a moveable pad, comprising:
sending a first message from the seismic source to the central control indicating a time at which the pad is being lowered;
estimating a time at which the pad will be acoustically coupled to the ground based on the first message; and
sending a message from the central control to the seismic source to begin a sweep, the sweep beginning no sooner than the estimated time.

2. The method of claim 1, wherein the time is estimated using at least one operating parameter of the seismic source.

3. The method of claim 1, wherein the estimated time includes a margin of safety.

4. The method of claim 1, wherein the estimated time is updated based on pad position measurements in the pad down position after the hold down weight is fully applied.

5. The method of claim 1, wherein the first message include an actual time at which the pad began being lowered.

6. The method of claim 1, wherein the first message includes a predicted time at which the pad will be lowered.

7. The method of claim 1, further comprising:
operating the seismic source at a first shot point; and
moving the seismic source to a second shot point, wherein the first message is sent before the seismic source arrives at the second shot point.

8. A method for performing a seismic survey using a central control and a seismic source carried by a truck, the seismic source having a vibrator that acoustically couples to the ground using a moveable pad, comprising:
mapping a surface of a terrain to be traversed by the truck using at least one sensor carried by the truck;
positioning a moveable pad based on the mapped surface to provide a physical gap between the surface and the moveable pad; and
traversing the mapped terrain with the truck.

9. The method of claim 8, wherein the moveable pad can be positioned at a pad down position, wherein the movable pad physically contacts the ground and a pad up position, wherein the movable pad is furthest from the pad down position, and wherein the moveable pad is positioned at an intermediate position between the pad down position and the pad up position based on the mapped surface.

10. The method of claim 9, further comprising:
operating the seismic source at a first shot point;
moving the seismic source to a second shot point; and
moving the pad from the pad down position to the intermediate position while moving the seismic source to the second shot point.

11. The method of claim 10, further comprising: moving the pad from the intermediate position to the pad down position after the seismic source arrives at the second shot point.

12. The method of claim 10, further comprising: moving the pad from the intermediate position to the pad down position before the seismic source arrives at the second shot point.

13. The method of claim 8, wherein the moveable pad is positioned using a safety margin.

14. The method of claim 8, wherein the pad position measurements in the pad down position prior to hold down weight being applied are used to update the calculated mean ground level.
